(19) United States
(12) Patent Application Publication
(10) Pub. No.: US 2024/0017584 A1
(43) Pub. Date: Jan. 18, 2024

(54) THERMAL MANAGEMENT DEVICE

(71) Applicants: TOYOTA JIDOSHA KABUSHIKI KAISHA, Toyota-shi (JP); SUBARU CORPORATION, Tokyo (JP)

(72) Inventors: Yoshio HASEGAWA, Toyota-shi (JP); Satoshi Furukawa, Kariya-shi (JP); Mitsuyo Omura, Kariya-shi (JP)

(73) Assignees: TOYOTA JIDOSHA KABUSHIKI KAISHA, Toyota-shi (JP); SUBARU CORPORATION, Tokyo (JP)

(21) Appl. No.: 18/214,621

(22) Filed: Jun. 27, 2023

(30) Foreign Application Priority Data
Jul. 14, 2022 (JP) 2022-113053

(51) Int. Cl. B60H 1/00; B60H 1/22; H01M 10/6551; H01M 10/48; H01M 10/63; H01M 10/6569; H01M 10/625

(52) U.S. Cl. CPC B60H 1/00278; B60H 1/00885; B60H 1/00328; B60H 1/2218; H01M 10/6551; H01M 10/486; H01M 10/63; H01M 10/6569; H01M 10/625; H01M 2220/20

(57) ABSTRACT

A thermal management device includes a first thermal circuit, a second thermal circuit, and a control unit. The first thermal circuit includes a first radiator and a battery. The second thermal circuit includes a heater, a temperature sensor, a first path, a second radiator, a second path, a heating appliance, and a flow rate adjusting unit. When a battery heating request and an air heating request are made, the control unit heats a second thermal transfer medium, and divides the flow of the second thermal transfer medium to the first and second paths. When a deficiency value of measured temperature with respect to a target temperature of the second thermal transfer medium is greater than a first threshold value in flow dividing processing, a second flow dividing proportion of the second path is set to be greater than a first flow dividing proportion of the first path.

### CROSS-REFERENCE TO RELATED APPLICATION

This application claims priority to Japanese Patent Application No. 2022-113053 filed on Jul. 14, 2022, incorporated herein by reference in its entirety.

### BACKGROUND

### 1. Technical Field

The technology disclosed in the present specification relates to a thermal management device.

### 2. Description of Related Art

Japanese Unexamined Patent Application Publication No. 2021-154814 (JP 2021-154814 A) discloses a thermal management device installed in a vehicle. This thermal management device has a plurality of thermal circuits (heater circuit, battery circuit, and so forth) through which a thermal transfer medium circulates. Air heating of a vehicle cabin can be performed by heating the thermal transfer medium in the heater circuit, using a heater. Also, a battery can be heated by transferring heat of the thermal transfer medium in the heater circuit to the battery circuit.

### SUMMARY

When a request for air heating by air conditioning and a request for battery heating are made at the same time, there is a problem in how to distribute heater capabilities to both requests.

A thermal management device disclosed in the present specification is installed in a vehicle. A thermal management device includes a first thermal circuit in which a first thermal transfer medium circulates, a second thermal circuit in which a second thermal transfer medium circulates, and a control unit. The first thermal circuit includes a first radiator and a battery. The second thermal circuit includes a heater that heats the second thermal transfer medium, a temperature sensor that is configured to be able to measure a temperature of the second thermal transfer medium and output a measured temperature, a first path, a second radiator that is disposed on the first path, and is configured such that heat is able to be exchanged between the first thermal transfer medium flowing through the first radiator and the second thermal transfer medium flowing through the second radiator, a second path that is parallel to the first path, a heating appliance that is disposed on the second path for performing air heating of a cabin of the vehicle using the second thermal transfer medium as a heat source, and a flow rate adjusting unit that is configured to be able to divide the flow of the second thermal transfer medium into the first path and the second path. When a battery heating request and an air heating request are made, the control unit executes flow dividing processing of heating the second thermal transfer medium by the heater, and also causing the flow rate adjusting unit to divide the flow of the second thermal transfer medium to the first path and the second path. In the flow dividing processing, when a deficiency value of the measured temperature with respect to a target temperature of the second thermal transfer medium is greater than a first threshold value that is set in advance, a second flow dividing proportion of the flow divided to the second path is set to be greater than a first flow dividing proportion of the flow divided to the first path.

According to this configuration, the first thermal transfer medium flowing through the first radiator can be heated by heat exchange between the second thermal transfer medium and the first thermal transfer medium, by the second thermal transfer medium that is heated and that flows over the first path. The battery can be heated by the first thermal transfer medium that is heated. Further, air heating of the inside of the vehicle cabin can be performed by the second thermal transfer medium that is heated and is flowing over the second path. When a battery heating request and an air heating request are made, the flow of the second thermal transfer medium that is heated can be divided to the first path and the second path, thereby enabling battery heating and air heating to be executed at the same time. At this time, priority can be given to executing air heating over battery heating, by making the second flow dividing proportion to be greater than the first flow dividing proportion. This enables giving priority to the air heating request intentionally selected by a driver, over the battery heating request.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a circuit diagram of a thermal management device 100;

FIG. 2 is a graph showing a form of controlling a valve opening degree;

FIG. 3A is a graph showing a specific example of control in flow dividing processing;

FIG. 3B is a graph showing a specific example of control in flow dividing processing; and

FIG. 4 is a circuit diagram of a thermal management device 100a according to a modification.

### DETAILED DESCRIPTION OF EMBODIMENTS

Technical elements of a thermal management device disclosed in the present specification are listed below. Note that technical elements below each independently exhibit utility.

In an example of the thermal management device disclosed in the present specification, a second threshold value that is smaller than a first threshold value may be set in advance. In flow dividing processing, when a deficiency value is greater than the first threshold value, a second flow dividing proportion may be controlled to a first fixed value. In the flow dividing processing, when the deficiency value is smaller than the second threshold value, the second flow dividing proportion may be controlled to a second fixed value that is smaller than the first fixed value. In the flow dividing processing, when the deficiency value is no greater than the first threshold value and no smaller than the second threshold value, the second flow dividing proportion may be controlled to be monotonously reduced from the first fixed value to the second fixed value in accordance with the deficiency value decreasing. According to this configuration, the second flow dividing proportion can be gradually reduced in accordance with the deficiency value becoming smaller than the first threshold value. This enables battery heating capabilities to be gradually raised as measured temperature of a second thermal transfer medium approaches a target temperature. More of capabilities of a heater can be allocated to heating the battery, while warming continues to be felt.

In an example of the thermal management device disclosed in the present specification, the higher an air heating load of a heating appliance is, the greater the first fixed value may be set to be. According to this configuration, air heating can be prioritized over battery heating as the heating load increases. This enables responsivity to air heating requests to be raised.

In an example of the thermal management device disclosed in the present specification, a control unit may be configured to variably control the target temperature of the second thermal transfer medium within a predetermined temperature range. When a battery heating request and an air heating request are made, the control unit may set the target temperature to an upper limit value within the predetermined temperature range. According to this configuration, the capabilities of the heater can be maximally utilized when executing battery heating and air heating at the same time. This enables responsivity to battery heating requests and air heating requests to be improved.

Configuration of Thermal Management Device 100

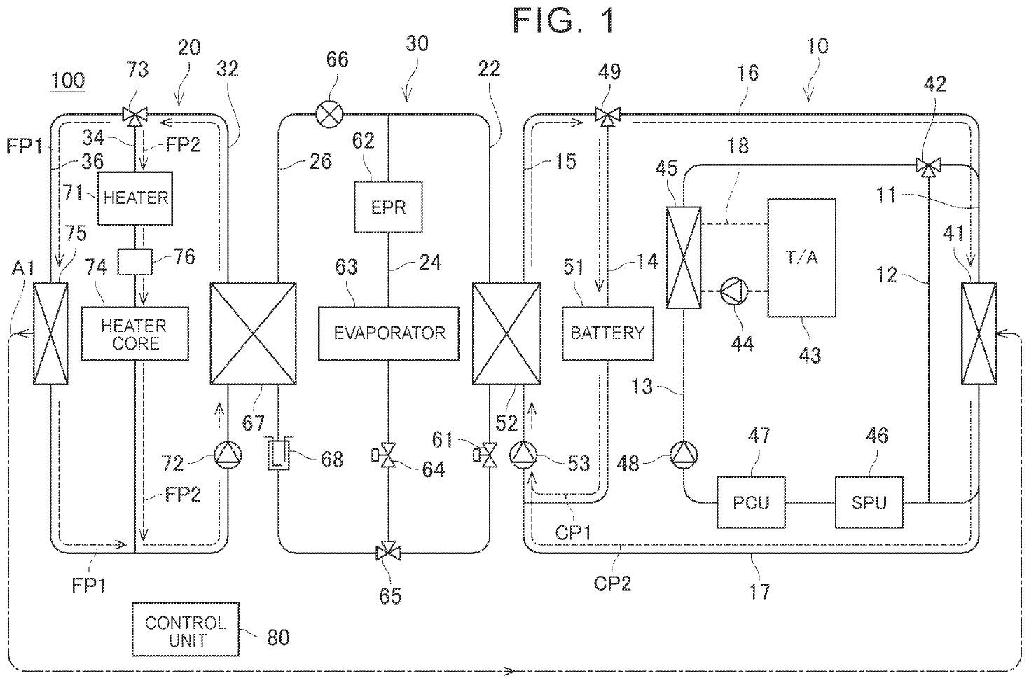

FIG. 1 illustrates a circuit diagram of a thermal management device 100 according to the present embodiment. The thermal management device 100 is installed in a vehicle. The thermal management device 100 has a control unit 80, a first thermal circuit 10, a second thermal circuit 20 and a third thermal circuit 30. The control unit 80 controls each part of the thermal management device 100. A first thermal transfer medium, a second thermal transfer medium, and a third thermal transfer medium each independently flow through the first thermal circuit 10, the second thermal circuit 20, and the third thermal circuit 30, respectively. The type of thermal transfer medium is not limited in particular, and hydrofluorocarbon can be used, for example.

The control unit 80 can execute cooling operations of cooling air in a vehicle cabin, using an evaporator 63. Also, the control unit 80 can execute air heating operations of heating the air in the vehicle cabin, using a heater core 74. Also, the control unit 80 can cool a battery 51, a transaxle 43, a power control unit (PCU) 47, and a smart power unit (SPU) 46. Further, the control unit 80 can heat the battery 51, the transaxle 43, the PCU 47, and the SPU 46.

The first thermal circuit 10 includes a low-temperature radiator path 11, a bypass path 12, an electrical equipment path 13, a battery path 14, a chiller path 15, and connecting paths 16 and 17.

A low-temperature radiator 41 is installed on the low-temperature radiator path 11. The low-temperature radiator 41 performs exchange of heat between the first thermal transfer medium in the low-temperature radiator path 11 and outside air (i.e., air outside the vehicle). A downstream end of the electrical equipment path 13 is connected to an upstream end of the bypass path 12 and an upstream end of the low-temperature radiator path 11, via a three-way valve 42. An upstream end of the electrical equipment path 13 is connected to a downstream end of the bypass path 12 and a downstream end of the low-temperature radiator path 11. A pump 48 is installed on the electrical equipment path 13. The pump 48 delivers the first thermal transfer medium in the electrical equipment path 13 downstream. The three-way valve 42 switches a flow path between a state in which the first thermal transfer medium flows from the electrical equipment path 13 to the low-temperature radiator path 11, and a state in which the first thermal transfer medium flows from the electrical equipment path 13 to the bypass path 12.

The SPU 46, the PCU 47, and an oil cooler 45 are installed on the electrical equipment path 13. The SPU 46 and the PCU 47 are heated or cooled by heat exchange with the first thermal transfer medium in the electrical equipment path 13. An oil circulation path 18 is connected to the oil cooler 45. The oil cooler 45 heats or cools oil in the oil circulation path 18 by heat exchange between the first thermal transfer medium in the electrical equipment path 13 and the oil in the oil circulation path 18. The oil circulation path 18 is laid out so as to pass through the interior of the transaxle 43. The transaxle 43 has built therein a traction motor that rotates driving wheels of the vehicle. An oil pump 44 is installed on the oil circulation path 18. The oil pump 44 causes the oil in the oil circulation path 18 to circulate. When the oil cooled by the oil cooler 45 circulates over the oil circulation path 18, the traction motor built into the transaxle 43 is cooled. The SPU 46 controls charging and discharging of the battery 51. The PCU 47 converts direct current electric power supplied from the battery 51 into alternating current electric power, and supplies the alternating current electric power to the motor built into in the transaxle 43.

A downstream end of the chiller path 15 is connected to an upstream end of the battery path 14 and an upstream end of the connecting path 16 via a three-way valve 49. An upstream end of the chiller path 15 is connected to a downstream end of the battery path 14 and a downstream end of the connecting path 17. An upstream end of the connecting path 17 is connected to a downstream end of the connecting path 16 by the low-temperature radiator path 11. A pump 53 is installed on the chiller path 15. The pump 53 delivers the first thermal transfer medium in the chiller path 15 downstream. The three-way valve 49 switches the flow path between a state in which the first thermal transfer medium flows from the chiller path 15 to the battery path 14 and a state in which the first thermal transfer medium flows from the chiller path 15 to the connecting path 16.

A chiller 52 is installed on the chiller path 15. The chiller 52 cools the first thermal transfer medium in the chiller path 15 by heat exchange between the first thermal transfer medium in the chiller path 15 and the third thermal transfer medium in the third thermal circuit 30.

The battery 51 is installed on the battery path 14. The battery 51 supplies direct current electric power to the PCU 47. The battery 51 is cooled or heated by heat exchange with the first thermal transfer medium in battery path 14.

The third thermal circuit 30 includes a chiller path 22, an evaporator path 24, and a condenser path 26. A downstream end of the condenser path 26 is connected to an upstream end of the chiller path 22 and an upstream end of the evaporator path 24 via a three-way valve 65. An upstream end of the condenser path 26 is connected to a downstream end of the chiller path 22 and a downstream end of the evaporator path 24. A compressor 66 is installed on the condenser path 26. The compressor 66 pressurizes and delivers downstream the third thermal transfer medium in the condenser path 26. The three-way valve 65 switches the flow path between a state in which the third thermal transfer medium flows from the condenser path 26 to the chiller path 22 and a state in which the third thermal transfer medium flows from the condenser path 26 to the evaporator path 24.

A condenser 67 and a modulator 68 are installed on the condenser path 26. The third thermal transfer medium, which is a high-temperature gas, flows into the condenser 67. The condenser 67 cools the third thermal transfer medium in the condenser path 26 by heat exchange between the third thermal transfer medium in the condenser path 26 and the second thermal transfer medium in the second thermal circuit 20. The third thermal transfer medium in the condenser path 26 is cooled inside the condenser 67, and thus is condensed. Accordingly, the third thermal transfer medium that has passed through the condenser 67 is a low-temperature liquid. The modulator 68 removes air bubbles from the third thermal transfer medium that is a liquid.

An expansion valve 61 and the chiller 52 are installed on the chiller path 22. The third thermal transfer medium that has passed through the modulator 68, and that is in the form of a low-temperature liquid, flows into the expansion valve 61. The third thermal transfer medium is decompressed when passing through the expansion valve 61. Accordingly, the third thermal transfer medium, which is a low-pressure and low-temperature liquid, flows into the chiller 52. The chiller 52 heats the third thermal transfer medium and cools the first thermal transfer medium, by heat exchange between the third thermal transfer medium in the chiller path 22 and the first thermal transfer medium in the chiller path 15. The third thermal transfer medium in the chiller path 22 that has passed the chiller 52 and that is in a high-temperature gaseous form is pressurized by the compressor 66 and sent to the condenser 67.

An expansion valve 64, the evaporator 63, and an evaporator pressure regulator (EPR) 62 are installed on the evaporator path 24. The third thermal transfer medium that has passed through the modulator 68, and that is in the form of a low-temperature liquid, flows into the expansion valve 64. The third thermal transfer medium is decompressed when passing through the expansion valve 64. Accordingly, the third thermal transfer medium, which is a low-pressure and low-temperature liquid, flows into the evaporator 63. The evaporator 63 heats the third thermal transfer medium and cools the air in the vehicle cabin, by heat exchange between the third thermal transfer medium in the evaporator path 24 and the air in the vehicle cabin. That is to say, the evaporator 63 executes cooling of the vehicle cabin. The EPR 62 controls the pressure inside the evaporator 63 to be substantially constant, by controlling the flow rate of the third thermal transfer medium within the evaporator path 24. The third thermal transfer medium that has passed through the EPR 62 (i.e., the third thermal transfer medium that is a high-temperature gas) is pressurized by the compressor 66 and sent to the condenser 67.

The second thermal circuit 20 includes a condenser path 32, a heater core path 34, and a high-temperature radiator path 36. A downstream end of the condenser path 32 is connected to an upstream end of the heater core path 34 and an upstream end of the high-temperature radiator path 36 via a three-way valve 73. An upstream end of the condenser path 32 is connected to a downstream end of the heater core path 34 and a downstream end of the high-temperature radiator path 36. That is to say, the heater core path 34 and the high-temperature radiator path 36 are disposed in parallel with respect to the condenser path 32.

A pump 72 and the condenser 67 are installed on the condenser path 32. The pump 72 delivers the second thermal transfer medium in the condenser path 32 downstream. The condenser 67 heats the second thermal transfer medium and cools the third thermal transfer medium by heat exchange between the second thermal transfer medium in the condenser path 32 and the third thermal transfer medium in the condenser path 26.

A heater 71, a temperature sensor 76, and the heater core 74 are installed on the heater core path 34. The heater 71 is a high-voltage electric heater, and heats the second thermal transfer medium. The temperature sensor 76 measures the temperature of the second thermal transfer medium, and outputs the measured temperature to the control unit 80. The heater core 74 heats the air in the vehicle cabin (performs air heating) by heat exchange between the second thermal transfer medium in the heater core path 34 and the air in the vehicle cabin.

A high-temperature radiator 75 is installed on the high-temperature radiator path 36. The high-temperature radiator 75 cools the second thermal transfer medium in the high temperature radiator path 36 by heat exchange between the second thermal transfer medium in the high temperature radiator path 36 and outside air. In the circuit diagram in FIG. 1, the high-temperature radiator 75 and the low-temperature radiator 41 are illustrated at positions away from each other, for the sake of ease of viewing the drawing. However, in the actual structure, the low-temperature radiator 41 and the high-temperature radiator 75 are integrally disposed as a radiator unit. Accordingly, a configuration is made in which heat exchange can be performed between the first thermal transfer medium flowing through the low-temperature radiator 41 and the second thermal transfer medium flowing through the high-temperature radiator 75.

The three-way valve 73 is a three-way governor valve that is configured to enable the flow of the second thermal transfer medium to be divided between the high-temperature radiator path 36 and the heater core path 34. The three-way valve 73 can variably control a first flow dividing proportion of dividing the flow to the high-temperature radiator path 36 and a second flow dividing proportion of dividing the flow to the heater core path 34. In the present embodiment, the three-way valve 73 includes a valve for controlling the second flow dividing proportion to the heater core path 34. When the opening degree of the valve is 100%, all of the second thermal transfer medium flows to the heater core path 34, and accordingly the second flow dividing proportion is 100% and the first flow dividing proportion is 0%. On the other hand, when the opening degree of the valve is 0%, all of the second thermal transfer medium flows to the high-temperature radiator path 36, and accordingly the second flow dividing proportion is 0% and the first flow dividing proportion is 100%. By adjusting the opening degree of the valve within the range of 0% to 100%, the first flow dividing proportion and the second flow dividing proportion can be controlled to desired values. Since there is a one-to-one correspondence between the opening degree of the valve and the second flow dividing proportion, the two may be used interchangeably in the present specification.

Battery Heating Operations and Air Heating Operations

Operations of the thermal management device 100 when a battery heating request and an air heating request are made to the control unit 80 concurrently will be described with reference to FIG. 1. A battery heating request is made when the temperature of the battery 51 is no greater than a reference value. Heating the battery enables the amount of input current to be increased during charging from an external charger or regenerative charging. An air heating request is made by a driver operating an air conditioner temperature adjustment dial that is omitted from illustration. A situation in which the battery heating request and the air heating request are made concurrently is not limited in particular. Examples include a situation in which the vehicle is connected to an external electric power supply for charging, a situation immediately after the vehicle is started, and so forth. Also, there is no limitation in particular as to whether the vehicle is in a stopped state or in a traveling state.

Operations of the second thermal circuit 20 will be described. When a battery heating request and an air heating request are made, the control unit 80 heats the second thermal transfer medium by operating the heater 71. The control unit 80 also controls the three-way valve 73 to execute flow dividing processing, for dividing the second thermal transfer medium to the high-temperature radiator path 36 and the heater core path 34. Thus, a flow path FP1 flowing over the high-temperature radiator path 36, and a flow path FP2 flowing over the heater core path 34, are formed. Based on the temperature measured by the temperature sensor 76, the control unit 80 variably controls a ratio between the first flow dividing proportion at which the flow of the second thermal transfer medium is divided to the high-temperature radiator path 36, and the second flow dividing proportion at which the flow of the second thermal transfer medium is divided to the heater core path 34. The content of this control will be described later.

Operations of the first thermal circuit 10 will be described. The control unit 80 operates the pump 53. Also, the control unit 80 controls the three-way valve 49 such that a state in which the chiller path 15 and the battery path 14 are connected, and a state in which the chiller path 15 and the connecting path 16 are connected, are established alternately. Accordingly, a state in which the first thermal transfer medium circulates through a circulation flow path CP1, and a state in which the first thermal transfer medium circulates through the circulation flow path CP2, are alternately switched. Now, the circulation flow path CP1 is a flow path made up of the chiller path 15 and the battery path 14. The circulation flow path CP2 is a flow path made up of the chiller path 15, the connecting path 16, the low-temperature radiator path 11, and the connecting path 17.

Battery heating operations will be described. Due to the second thermal transfer medium heated by the heater 71 flowing over the high-temperature radiator path 36, the second thermal transfer medium of which the temperature is high flows into the high-temperature radiator 75 (see flow path FP1). The heat of the second thermal transfer medium flowing through the high-temperature radiator 75 is transferred to the first thermal transfer medium flowing through the low-temperature radiator 41 (see long dashed short dashed line arrow A1). The first thermal transfer medium can be heated by heat exchange between the second thermal transfer medium and the first thermal transfer medium. Accordingly, the first thermal transfer medium, of which the temperature is high due to being heated by the low-temperature radiator 41, flows over the circulation flow path CP2. The first thermal transfer medium of which the temperature is high reaches the three-way valve 49. When the three-way valve 49 is switched so as to switch from the state in which the first thermal transfer medium circulates over the circulation flow path CP2 to the state in which the first thermal transfer medium circulates over the circulation flow path CP1, the first thermal transfer medium of which the temperature is high flows into the battery path 14, and the battery 51 is heated.

Air heating operations will be described. Due to the second thermal transfer medium heated by the heater 71 flowing over the heater core path 34, the second thermal transfer medium of which the temperature is high flows into the heater core 74 (see flow path FP2). The heater core 74 heats the air in the vehicle cabin by heat exchange between the second thermal transfer medium and the air in the vehicle cabin. Thus, air heating of the vehicle cabin is executed.

Flow Dividing Processing by Three-Way Valve 73

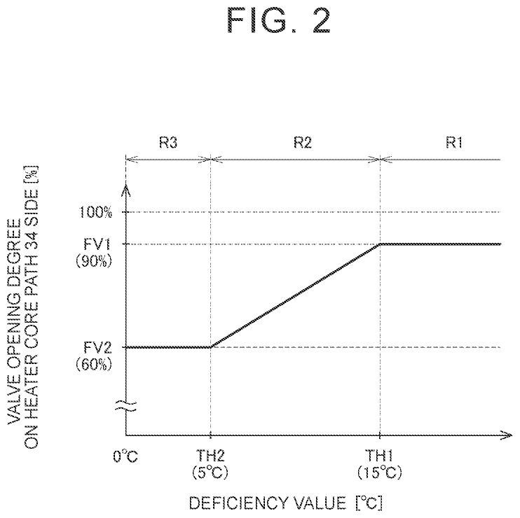

The flow dividing processing performed by the three-way valve 73 will be described with reference to FIG. 2. FIG. 2 is a graph showing a form of controlling a valve opening degree. The vertical axis in FIG. 2 is the valve opening degree on the heater core path 34 side. The horizontal axis in FIG. 2 is a deficiency value of a measured temperature TW with respect to a target temperature TWO of the second thermal transfer medium. The target temperature TWO is a temperature set by the control unit 80 in accordance with the air heating load. The air heating load is calculated based on, for example, the necessary blowing temperature at air conditioner blowing vents, temperature in the cabin, temperature of the air outside, and so forth. The measured temperature TW is the current temperature of the second thermal transfer medium, measured by the temperature sensor 76. The deficiency value is a value obtained by subtracting the measured temperature TW from the target temperature TWO. That is to say, the deficiency value is a positive value when the measured temperature TW is lower than the target temperature TWO.

The control unit 80 is configured to be able to variably control the target temperature TWO within a predetermined temperature range. When the battery heating request and the air heating request are made concurrently, the control unit 80 sets the target temperature TWO to the upper limit value within a predetermined temperature range. There are various methods for setting the upper limit value. For example, when an overheating temperature (e.g., 70° C.) of the heater 71 is set in advance, a temperature that is lower by a margin such that overheating does not occur (e.g., 65° C.) may be set as the upper limit. According to this configuration, the capabilities of the heater can be maximally utilized when executing battery heating and air heating at the same time. This enables responsivity to battery heating requests and air heating requests to be improved.

A first threshold value TH1 and a second threshold value TH2 are set in advance for the deficiency value. The second threshold value TH2 is a value that is smaller than the first threshold value TH1. In the example in FIG. 2, the first threshold value TH1 is 15° C., and the second threshold value TH2 is 5° C. Also, a first fixed value FV1 and a second fixed value FV2 are set in advance for the valve opening degree. The first fixed value FV1 is a value that is greater than 50%. That is to say, the first fixed value FV1 is set to a value such that the second flow dividing proportion for dividing the flow to the heater core path 34 is greater than the first dividing proportion for dividing the flow to the high-temperature radiator path 36. Also, the second fixed value FV2 is a value that is smaller than the first fixed value FV1. In the example in FIG. 2, the first fixed value FV1 is 90%, and the second fixed value FV2 is 60%.

In the flow dividing processing, when the deficiency value is greater than the first threshold value TH1 (see region R1), the valve opening degree is set to the first fixed value FV1 (90%). That is to say, the second flow dividing proportion is controlled to a constant value corresponding to the first fixed value FV1. Also, when the deficiency value is smaller than the second threshold value TH2 (see region R3), the valve opening degree is set to the second fixed value FV2 (60%). That is to say, the second flow dividing proportion is controlled to a constant value corresponding to the second fixed value FV2. Further, when the deficiency value is no greater than the first threshold value TH1 and no smaller than the second threshold value TH2 (see region R2), the valve opening degree is controlled to be monotonously reduced from the first fixed value FV1 to the second fixed value FV2 in accordance with the deficiency value decreasing.

Specific Example of Flow Dividing Processing

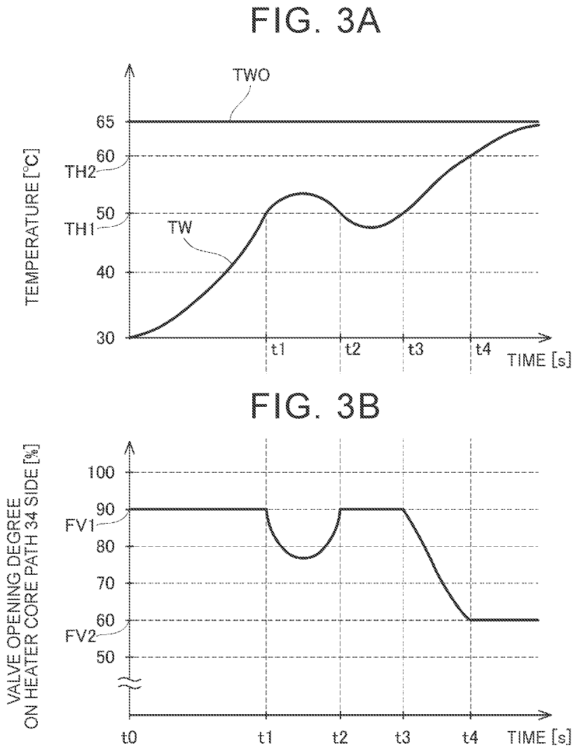

A specific example of control in flow dividing processing will be described with reference to FIGS. 3A and 3B. FIG. 3A is a graph showing temporal change in the measured temperature TW. The horizontal axis is time and the vertical axis is temperature. FIG. 3A shows a case in which the target temperature TWO is 65° C., the first threshold value TH1 is 15° C., and the second threshold value TH2 is 5° C. Accordingly, the first threshold value TH1 corresponds to 50° C., and the second threshold value TH2 corresponds to 60° C. FIG. 3B is a graph showing temporal change in the valve opening degree. The horizontal axis is time and the vertical axis is the valve opening degree.

A case in which an ignition switch of the vehicle is turned on at time t0 will be described. Also, a case in which an air heating request and a battery heating request are made concurrently at time t0 will be described. At time to, the deficiency value of the measured temperature TW with respect to the target temperature TWO is 35° C. The deficiency value is greater than the first threshold value TH1 (15° C.), and accordingly the control unit 80 controls the valve opening degree to the first fixed value FV1 (90%) (see region R1 in FIG. 2). Also, the control unit 80 causes the heater 71 to start operating, and accordingly the measured temperature TW starts to rise.

Accordingly, when a battery heating request and an air heating request are made concurrently, the flow of the heated second thermal transfer medium can be divided to the high-temperature radiator path 36 and the heater core path 34. This enables battery heating and air heating to be executed at the same time. Also, a period in which the deficiency value is greater than the first threshold value TH1 (15° C.) is a period in which warming is not sufficiently felt yet. During this period, by allowing more of the second thermal transfer medium to flow through the heater core path 34 enables air heating to be executed with priority over battery heating. This enables giving priority to the air heating request intentionally selected by a driver, over the battery heating request. Also, a small amount of heat can be transferred to the battery 51 to the extent that warming is still felt.

At time t1, when the measured temperature TW rises to 50° C., the deficiency value becomes smaller than the first threshold value TH1 (15° C.). During the period from time t1 to time t2, the control unit 80 variably controls the valve opening degree in accordance with change in the deficiency value (see region R2 in FIG. 2). During the period from time t2 to time t3, when the measured temperature TW falls below 50° C. again, the control unit 80 controls the valve opening degree to the first fixed value FV1 (90%). During the period from time t3 to time t4, the control unit 80 reduces the valve opening degree from 90% to 60%, in response to the measured temperature TW rising from 50° C. to 60° C. After time t4, when a state in which the measured temperature TW is higher than 60° C. is maintained, the deficiency value is maintained at a state of being lower than the second threshold value TH2. Accordingly, the control unit 80 controls the valve opening degree to the second fixed value FV2 (60%) (see region R3 in FIG. 2).

A period in which the deficiency value is smaller than the first threshold value TH1 (15° C.) is a period in which warming is felt to a certain extent. During this period, in accordance with the deficiency value becoming smaller than the first threshold value, the proportion of the flow divided to the heater core path 34 is gradually reduced, and the proportion of the flow divided to the high-temperature radiator path 36 is increased. This enables the battery heating capabilities to be gradually raised as the measured temperature TW approaches the target temperature TWO. More of the capabilities of the heater 71 can be allocated to heating the battery, while warming continues to be felt.

Corresponding Relations

The low-temperature radiator 41 is an example of a first radiator. The high-temperature radiator 75 is an example of a second radiator. The high-temperature radiator path 36 is an example of a first path. The heater core path 34 is an example of a second path. The three-way valve 73 is an example of a flow rate adjusting unit. The heater core 74 is an example of a heating appliance.

Although an embodiment is described in detail above, the embodiment is merely exemplary, and is not intended to limit the scope of the claims. The technology described in the claims includes various modifications and alterations of the specific examples illustrated above.

Modification

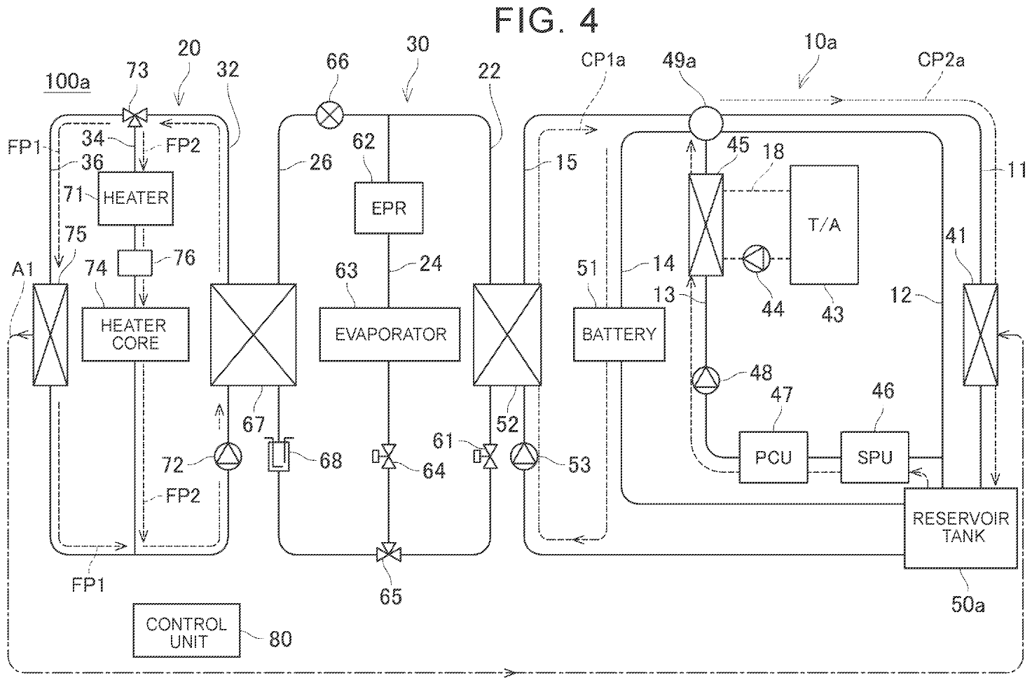

The configuration of the first thermal circuit 10 may vary. A form may be made in which a five-way valve 49a is included, as in a first thermal circuit 10a of a thermal management device 100a according to a modification illustrated in FIG. 4. Common parts between the thermal management device 100a illustrated in FIG. 4 and the thermal management device 100 illustrated in FIG. 1 are denoted by the same signs, and description thereof will be omitted. Also, parts unique to the thermal management device 100a are distinguished by adding “a” to the end of the signs. In the thermal management device 100a, the five-way valve 49a alternately switches between a state in which the first thermal transfer medium circulates through a circulation flow path CP1a, and a state in which the first thermal transfer medium circulates through a circulation flow path CP2a. Now, the circulation flow path CP1a is a flow path made up of the chiller path 15 and the battery path 14. The circulation flow path CP2a is a flow path made up of the low-temperature radiator path 11 and the electrical equipment path 13. This configuration also enables the battery 51 to be heated using the heater 71.

Various methods may be used to set the first fixed value FV1, the second fixed value FV2, the first threshold value TH1, and the second threshold value TH2. For example, the first fixed value FV1 and the second fixed value FV2 may be set to be higher the higher the air heating load is. Also, the first threshold value TH1 and the second threshold value TH2 may be set to be lower the higher the air heating load is. According to this configuration, air heating can be prioritized over battery heating as the heating load increases. This enables responsivity to air heating requests to be raised.

The positional relation between the three-way valve 73 and the heater 71 disposed on the second thermal circuit 20 may vary. For example, the heater 71 may be disposed on the condenser path 32. In this case, the heater 71 may be disposed between the three-way valve 73 and the condenser 67.

In the present embodiment, a case has been described in which no dedicated heater for heating the first thermal transfer medium in the battery path 14 is disposed in the first thermal circuit 10. However, in a modification, a heater that heats the first thermal transfer medium may be disposed on the battery path 14.

In the present embodiment, a case has been described in which the three-way valve 49 of the first thermal circuit 10 switches the flow path between a state in which the thermal transfer medium flows from the chiller path 15 to the battery path 14, and a state in which the thermal transfer medium flows from the chiller path 15 to the connecting path 16. However, in addition to the above states, the three-way valve 49 may be capable of switching the flow path to a state in which the thermal transfer medium flows from the chiller path 15 to both the battery path 14 and the connecting path 16.

The technical elements described in the present specification or the drawings exhibit technical usefulness alone or in various combinations, and are not limited to the combinations described in the claims at the time of filing. Also, the technologies exemplified in the present specification or in the drawings may simultaneously achieve a plurality of objects, and exhibit technical utility by achieving one of the objects.

What is claimed is:

1. A thermal management device installed in a vehicle, the thermal management device comprising: a first thermal circuit in which a first thermal transfer medium circulates; a second thermal circuit in which a second thermal transfer medium circulates; and a control unit, wherein:
the first thermal circuit includes
a first radiator and
a battery;
the second thermal circuit includes
a heater that heats the second thermal transfer medium,
a temperature sensor that is configured to be able to measure a temperature of the second thermal transfer medium and output a measured temperature,
a first path,
a second radiator that is disposed on the first path, and is configured such that heat is able to be exchanged between the first thermal transfer medium flowing through the first radiator and the second thermal transfer medium flowing through the second radiator,
a second path that is parallel to the first path,
a heating appliance that is disposed on the second path for performing air heating of a cabin of the vehicle using the second thermal transfer medium as a heat source, and
a flow rate adjusting unit that is configured to be able to divide the flow of the second thermal transfer medium into the first path and the second path;
when a battery heating request and an air heating request are made, the control unit executes flow dividing processing of heating the second thermal transfer medium by the heater, and also causing the flow rate adjusting unit to divide the flow of the second thermal transfer medium to the first path and the second path; and
in the flow dividing processing, when a deficiency value of the measured temperature with respect to a target temperature of the second thermal transfer medium is greater than a first threshold value that is set in advance, a second flow dividing proportion of the flow divided to the second path is set to be greater than a first flow dividing proportion of the flow divided to the first path.

2. The thermal management device according to claim 1, wherein a second threshold value that is smaller than the first threshold value is set in advance, and in the flow dividing processing,
when the deficiency value is greater than the first threshold value, the second flow dividing proportion is controlled to a first fixed value,
when the deficiency value is smaller than the second threshold value, the second flow dividing proportion is controlled to a second fixed value that is smaller than the first fixed value, and
when the deficiency value is no greater than the first threshold value and no smaller than the second threshold value, the second flow dividing proportion is controlled to be monotonously reduced from the first fixed value to the second fixed value in accordance with the deficiency value decreasing.

3. The thermal management device according to claim 2, wherein the higher an air heating load of the heating appliance is, the greater the first fixed value is set to be.

4. The thermal management device according to claim 1, wherein:
the control unit is configured to be able to variably control the target temperature of the second thermal transfer medium within a predetermined temperature range; and
when the battery heating request and the air heating request are made, the control unit sets the target temperature to an upper limit value within the predetermined temperature range.
